(19) United States
(12) Patent Application Publication
(10) Pub. No.: US 2022/0012119 A1
(43) Pub. Date: Jan. 13, 2022

(54) MULTIPLE MODULE SCHEDULING DEVICE AND SYSTEM

(71) Applicant: RTST CO., LTD., Daejeon (KR)

(72) Inventor: Hwayoung LEE, Daejeon (KR)

(73) Assignee: RTST CO., LTD., Daejeon (KR)

(21) Appl. No.: 17/294,687

(22) PCT Filed: Nov. 28, 2018
(86) PCT No.: PCT/KR2018/014761

§ 371 Date: May 18, 2021

(30) Foreign Application Priority Data
Nov. 23, 2018 (KR) 10-2018-0146104

(51) Int. Cl. G06F 11/07; G06F 9/48

(52) U.S. Cl. CPC G06F 11/0793; G06F 9/4881; G06F 11/0751; G06F 11/0721

(57) ABSTRACT

The present invention relates to a multiple module scheduling device and system. A multiple module scheduling device according to one embodiment of the present invention comprises: a scheduling management unit for determining scheduling, before execution thereof, of a partition for each of a plurality of modules and controlling the execution of the partition for each module according to the determined scheduling; an error monitoring unit for monitoring error information occurring in the plurality of modules; and an error control unit for receiving the error information from the error monitoring unit, and performing control so as to perform a predetermined recovery action on the basis of the received error information.

### TECHNICAL FIELD

The present disclosure relates to a multiple module scheduling device and system, and is produced by a research project “Development of software black box technology for high-reliability computing” conducted with the support of “Ministry of Science and Technology Information and Communication in the Republic of Korea”.

### BACKGROUND ART

To build a safe system, an operating system for a safety-first system such as a vehicle or an aircraft organizes an application into partitions, and a partition is composed of several processes. Partitioning used herein refers to a scheme that minimizes interference between applications, each of which is composed of partitions, and operates an application itself separately from another application.

A conventional system, to which the scheduling of multiple modules is applied, may have only a single error monitoring rule, and thus may not perform an error monitoring function optimized for each scheduling. Accordingly, when an error occurs, the conventional system may not efficiently perform a recovery action.

### DETAILED DESCRIPTION OF THE INVENTION

### Technical Problem

The present disclosure provides a device capable of performing error handling optimized for each scheduling by applying an error monitoring scheme having a separate rule for each scheduling applied to multiple modules.

### Technical Solution

According to an aspect of the present disclosure, a multiple module scheduling device may include a scheduling management unit determining scheduling of a partition for each of a plurality of modules before execution of the partition and controlling the execution of the partition for each module depending on the determined scheduling, an error monitoring unit monitoring error information occurring in the plurality of modules, and an error control unit receiving the error information from the error monitoring unit, and controlling a predetermined recovery action to be performed based on the received error information.

Furthermore, the error information may include a state of a system and an error type of the system.

Moreover, the error control unit may compare the error information with a system level monitoring table and may determine that the error information corresponds to an error at a module level or an error at a partition level.

Also, when it is determined that the error information corresponds to the error at the module level, the error control unit may compare the error information with a module level monitoring level table, may determine a recovery action corresponding to the error information, and may control the determined recovery action to be performed.

In addition, when it is determined that the error information corresponds to the error at the partition level, the error control unit may compare the error information with a partition level monitoring level table, may determine the recovery action corresponding to the error information, and may control the determined recovery action to be performed.

Besides, in a scheduling monitoring system using the multiple module scheduling device, the multiple module scheduling device may include system level monitoring tables, of which the number is the same as the number of the modules, module level monitoring tables, of which the number is the same as the number of the modules, and partition level monitoring tables, of which the number is the same as the number of the modules.

### Advantageous Effects of the Invention

According to an embodiment of the present disclosure, it is possible to perform error handling optimized for each scheduling by applying an error monitoring scheme having a separate rule for each scheduling applied to multiple modules.

### DESCRIPTION OF THE DRAWINGS

FIG. 1 is a block diagram of a multi-module system, according to an embodiment of the present disclosure.

FIG. 2 is a block diagram of a multiple module scheduling device, according to an embodiment of the present disclosure.

FIG. 3 is a flowchart illustrating a procedure, in which a multiple module scheduling device processes an error occurring in a system, according to an embodiment of the present disclosure.

FIG. 4 is a diagram for describing a system level monitoring table according to an embodiment of the present disclosure.

FIG. 5 is a diagram for describing a module level monitoring table, according to an embodiment of the present disclosure.

FIG. 6 is a diagram for describing a partition level monitoring table according to an embodiment of the present disclosure.

FIG. 7 is a diagram for describing a monitoring table in a multiple module scheduling device, according to an embodiment of the present disclosure.

### BEST MODE

According to an embodiment of the present disclosure, other advantages and features and methods of accomplishing the same may be understood more readily with reference to the following detailed description of an embodiment and the accompanying drawings. The present disclosure, however, may be embodied in various different forms, and should not be construed as being limited only to the illustrated embodiments. Rather, these embodiments are provided as examples so that the disclosure will be thorough and complete, and will fully convey the category of the present disclosure to those skilled in the art. The present disclosure may be defined by scope of the claims. Meanwhile, the terminology used herein to describe embodiments of the present disclosure is not intended to limit the scope of the present disclosure.

Even though it is not defined, all terms (including technical or scientific terms) used herein have the same meaning as being generally accepted by the general technology in the art belonging to present disclosure. Terms defined by general dictionaries may be construed as having the same meaning as the related technology and/or body of this application, and will not be conceptualized or construed excessively formally, even though being not clearly defined herein.

The terms used in the specification are provided to describe the embodiments, not to limit the present disclosure. In the specification, the singular forms include plural forms unless particularly mentioned. The terms “comprises” and/or various conjugated forms of this verb such as ‘inclusion’, ‘comprising’, ‘including’, and ‘containing’ used herein does not exclude presence or addition of one or more other different compositions, ingredients, components, steps, operations, and/or elements in addition to the aforementioned compositions, ingredients, components, steps, operations, and/or elements. In the present specification, the term ‘and/or’ refers to each of the listed configurations or various combinations thereof.

Meanwhile, terms such as ‘˜ unit’, ‘˜ device’, ‘˜ block’, ‘module’, or the like used throughout the present specification may mean a unit that processes at least one function or operation. For example, it may mean software or hardware components such as FPGA or ASIC. However, ‘˜ unit’, ‘˜ device’, ‘˜ block’, ‘module’, or the like may not be limited to software or hardware. For example, ‘˜ unit’, ‘˜ device’, ‘˜ block’, or ‘module’ may be configured to be stored in an addressable storage medium or may be configured to execute one or more processors.

Therefore, as an example, ‘˜ unit’, ‘˜ device’, ‘˜ block’, or ‘module’ may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in components and ‘˜ unit’, ‘˜ device’, ‘˜ block’, and ‘˜module’ may be combined with the smaller number of components and ‘˜ unit’, ‘˜ device’, ‘˜ block’, and ‘˜module’ or may be further divided into additional components and ‘˜ unit’, ‘˜ device’, ‘˜ block’, and ‘˜module’.

Below, embodiments of the present disclosure will be more fully described with reference to accompanying drawings.

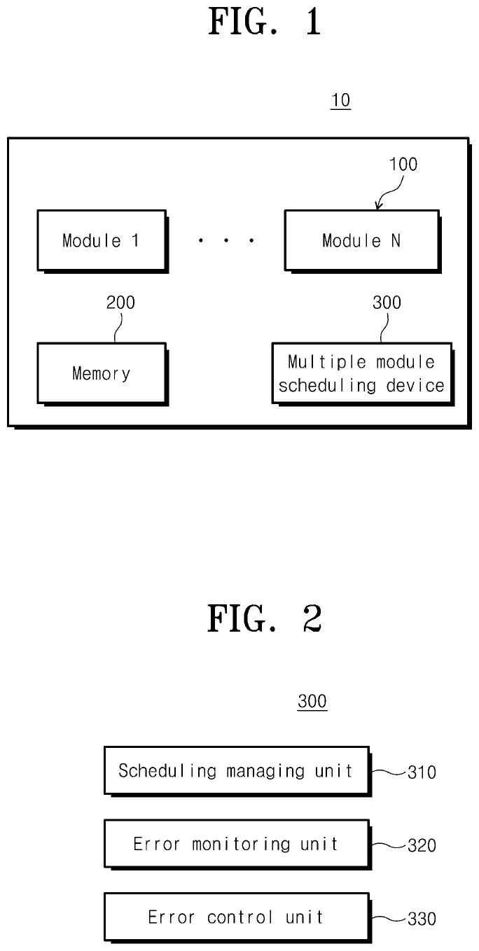

FIG. 1 is a block diagram of a multi-module system 10, according to an embodiment of the present disclosure.

Referring to FIG. 1, the multi-module system 10 includes a plurality of modules 100, a memory 200, and a multiple module scheduling device 300.

The modules 100 execute application-related partitions, respectively. The memory 200 stores data for modules and partitions. The multiple module scheduling device 300 processes errors, which occur depending on a schedule determined in a system, at a module level and a partition level.

The multi-module system 10 includes two or more modules. The plurality of modules share memory resources and execute partitions. In an embodiment of the present disclosure, as described below, the multiple module scheduling device 300 processes an error, which occurs in a procedure of processing data based on the scheduling determined for each module, depending on a predefined recovery action.

The recovery action is different depending on various situations that occur while various application programs are executed for each module. As a result, the multiple module scheduling device 300 may perform a recovery action on an error, which occurs for each module, based on a predetermined recovery action, thereby effectively processing an error occurring between modules in a multi-module environment.

FIG. 2 is a block diagram of the multiple module scheduling device 300, according to an embodiment of the present disclosure.

Referring to FIG. 2, the multiple module scheduling device 300 includes a scheduling managing unit 310, an error monitoring unit 320, an error control unit 330.

The scheduling managing unit 310 statically defines scheduling of a partition for each of a plurality of modules in advance before the execution of the partition, and controls the execution of the partition for each module depending on the defined scheduling. The error monitoring unit 320 monitors error information including system state of an error occurring in a system, and an error type of the system. The error control unit 330 receives error information from the error monitoring unit 320, compares error information with a system level monitoring table, a module level monitoring table, and a partition level monitoring table, and controls a predetermined recovery action to be performed. Herein, it is preferable that the number of system level monitoring tables is the same as the number of multiple modules, the number of module level monitoring tables is the same as the number of multiple modules, and the number of partition level monitoring tables is the same as the number of multiple modules.

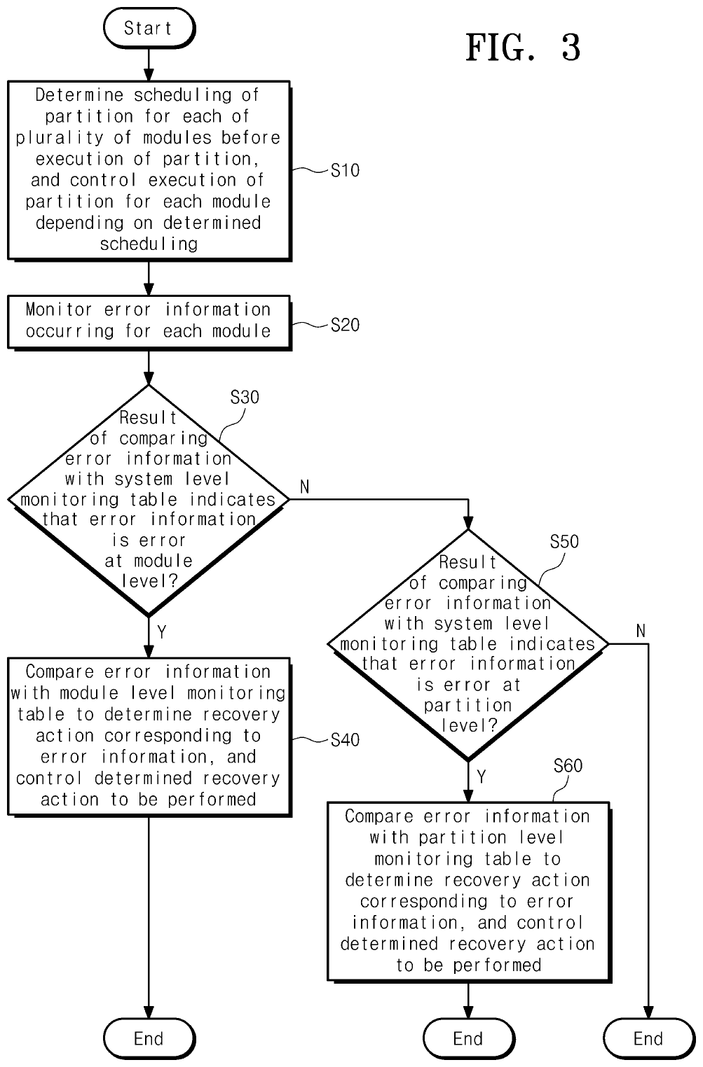

FIG. 3 is a flowchart illustrating a procedure, in which the multiple module scheduling device 300 processes an error occurring in a system, according to an embodiment of the present disclosure.

Referring to FIG. 3, first of all, the multiple module scheduling device 300 statically determines scheduling of a partition for each of a plurality of modules before execution of the partition, and executes each application program depending on a scheduling rule predetermined before the execution of the partition (S10).

When an error occurs in a system in a procedure of executing an application program, the multiple module scheduling device 300 monitors error information including a state of the system and an error type of the system (S20). The multiple module scheduling device 300 compares an error occurring at a system level with the system level monitoring table, and determines whether the error is an error at a module level or at the partition level (S30 and S50).

When it is determined that the error is an error at the module level, the multiple module scheduling device 300 compares the error with to a module level monitoring table, and then controls a predetermined recovery action to be performed (S40). When it is determined that the error is an error at the partition level, the multiple module scheduling device 300 compares the error with a partition level monitoring table, and then controls a predetermined recovery action to be performed (S60).

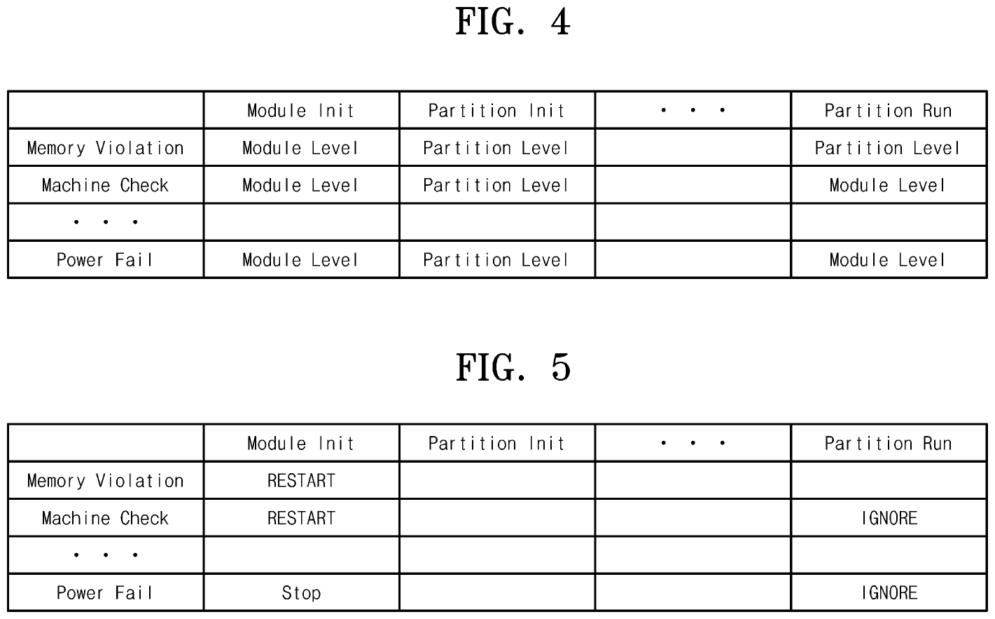

Hereinafter, the procedure will be described in detail with reference to FIGS. 4 to 7.

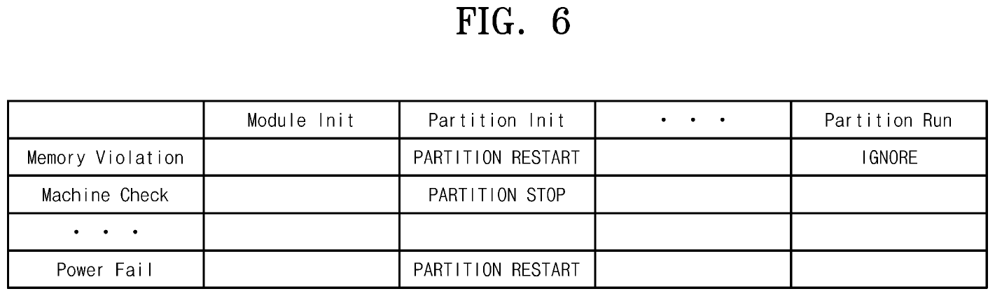

FIG. 4 is a diagram for describing a system level monitoring table, according to an embodiment of the present disclosure. FIG. 5 is a diagram for describing a module level monitoring table, according to an embodiment of the present disclosure. FIG. 6 is a diagram for describing a partition level monitoring table, according to an embodiment of the present disclosure.

Referring to FIG. 5, when error information corresponds to an error at a module level, it is possible to identify a recovery action. Referring to FIG. 6, when error information corresponds to an error at a partition level, it is possible to identify a recovery action. Furthermore, a row of each table in FIGS. 4 to 6 indicates a state of a system. A column of each table indicates an error type of the system.

For example, when the system state of the error information occurring in the system in operation S20 is ‘Module Init’, and the error type of the error information is ‘Memory Violation’, it may be identified that the error information corresponds to a module level error (See FIG. 4). The error information corresponds to a module level error, and thus there is a need to identify a module level monitoring table of FIG. 5.

Afterward, because the system state of the error information occurring in the system is ‘Module Init’, and the error type of the error information is ‘Memory Violation’, it is possible to perform a recovery action, which is referred to as ‘RESTART’ in the module level monitoring table (See FIG. 5). Herein, the recovery action is defined as at least one of ‘RESTART’, ‘STOP’, and ‘IGNORE’.

As another example, when the system state of the error information occurring in the system in operation S20 is ‘Partition Init’, and the error type of the error information is ‘Machine Check’, it may be identified that the error information corresponds to a partition level error (See FIG. 4). The error information corresponds to a partition level error, and thus there is a need to identify a partition level monitoring table of FIG. 6.

Afterward, because the system state of the error information occurring in the system is ‘Partition Init’, and the error type of the error information is ‘Memory Check’, it is possible to perform a recovery action, which is referred to as ‘PARTITION STOP’ in the partition level monitoring table (See FIG. 6).

As such, when an error occurs in the system, it is possible to perform a predetermined recovery action by comparing the error information with the module level monitoring table of FIG. 5 or the partition level monitoring table of FIG. 6 based on the system level monitoring table of FIG. 4.

The conventional scheduling system may define only a single monitoring rule in a module, and thus the conventional scheduling system may not perform error monitoring optimized for each scheduling in a system to which multiple modules are applied. As a result, when the multiple module scheduling device 300 is used, it is possible to apply monitoring having a predetermined recovery action for each scheduling according to each module, thereby performing error handling optimized for each scheduling.

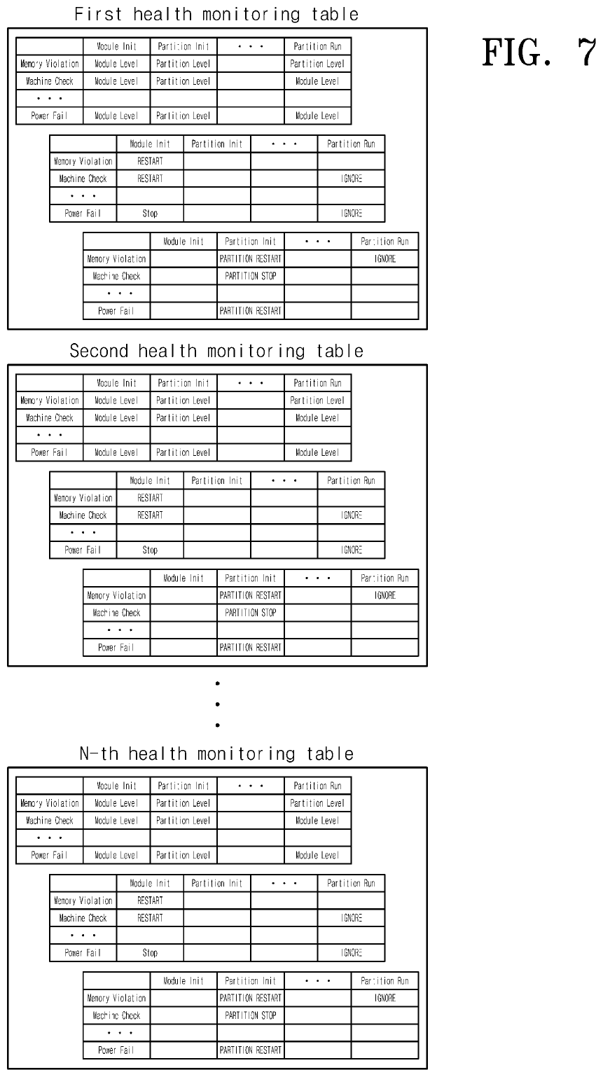

FIG. 7 is a diagram for describing a monitoring table in a multiple module scheduling device, according to an embodiment of the present disclosure. Herein, the number of system level monitoring tables is the same as the number of multiple modules; the number of module level monitoring tables is the same as the number of multiple modules; and, the number of partition level monitoring tables is the same as the number of multiple modules. Error types of a system and states of the system illustrated in FIGS. 4 to 7 are examples, and may be different from one another for each system.

The above description exemplifies the present disclosure. Furthermore, the above-mentioned contents describe exemplary embodiments of the present disclosure, and the present disclosure may be used in various other combinations, changes, and environments. That is, variations or modifications can be made to the present disclosure without departing from the scope of the present disclosure that is disclosed in the specification, the equivalent scope to the written disclosures, and/or the technical or knowledge range of those skilled in the art. The written embodiments describe the best state for implementing the technical spirit of the present disclosure, and various changes required in specific applications and purposes of the present disclosure can be made. Accordingly, the detailed description of the present disclosure is not intended to restrict the present disclosure in the disclosed embodiment state. In addition, it should be construed that the attached claims include other embodiments.

What is claimed is:

1. A multiple module scheduling device comprising:
a scheduling management unit configured to determine scheduling of a partition for each of a plurality of modules before execution of the partition and to control the execution of the partition for each module depending on the determined scheduling;
an error monitoring unit configured to monitor error information occurring in the plurality of modules; and
an error control unit configured to receive the error information from the error monitoring unit, and to control a predetermined recovery action to be performed based on the received error information.

2. The multiple module scheduling device of claim 1, wherein the error information includes a state of a system and an error type of the system.

3. The multiple module scheduling device of claim 2, wherein the error control unit compares the error information with a system level monitoring table and determines that the error information corresponds to an error at a module level or an error at a partition level.

4. The multiple module scheduling device of claim 3, wherein, when it is determined that the error information corresponds to the error at the module level, the error control unit compares the error information with a module level monitoring level table, determines a recovery action corresponding to the error information, and controls the determined recovery action to be performed.

5. The multiple module scheduling device of claim 4, wherein, when it is determined that the error information corresponds to the error at the partition level, the error control unit compares the error information with a partition level monitoring level table, determines the recovery action corresponding to the error information, and controls the determined recovery action to be performed.

6. A scheduling monitoring system using the multiple module scheduling device of claim 5, the multiple module scheduling device including system level monitoring tables, of which the number is the same as the number of the modules, module level monitoring tables, of which the number is the same as the number of the modules, and partition level monitoring tables, of which the number is the same as the number of the modules.
